(19) United States
(12) Patent Application Publication
(10) Pub. No.: US 2014/0237110 A1
(43) Pub. Date: Aug. 21, 2014

(54) SERVER MONITORING

(71) Applicant: NEC BIGLOBE, LTD., Tokyo (JP)

(72) Inventors: TOSHIKO NAKANISHI, Tokyo (JP); RIHITO KATO, Tokyo (JP); MASARU SUGAI, Tokyo (JP)

(73) Assignee: NEC BIGLOBE, LTD., Tokyo (JP)

(21) Appl. No.: 14/172,476

(22) Filed: Feb. 4, 2014

(30) Foreign Application Priority Data
Feb. 18, 2013 (JP) 2013-028713

(51) Int. Cl. H04L 12/26

(52) U.S. Cl. CPC H04L 43/10
USPC 709/224

(57) ABSTRACT

A monitoring device monitors operation states of servers. If information that indicates the operation states is requested from a supervisor terminal, the monitoring device generates display information that allows the supervisor terminal to graphically display the operation states and process commands for the servers and transmits the generated display information to the supervisor terminal. If process commands are transmitted from the supervisor terminal, the monitoring device causes the servers to execute processes based on the transmitted commands.

This application is based upon and claims the benefit of priority from Japanese Patent Application No. 2013-028713 filed on Feb. 18, 2013, the content of which is incorporated by reference.

### TECHNICAL FIELD

The present invention relates to monitoring devices, monitoring systems, monitoring methods, and programs that monitor servers.

### BACKGROUND ART

Generally, the management state and operation state of a system are monitored in such a manner that a communication device such as a PC (Personal Computer) is connected to a dedicated communication line that is connected both to servers comprising the system and to a monitoring device that monitors the servers and that predetermined commands are input to the communication device.

In addition, a technique that periodically notifies a client terminal subscribing to a service provided by a server of its service providing state has been proposed (for example, refer to Patent Literature 1).

### CITATION LIST

### Patent Literature

Patent Literature 1

JP2000-194627A, Publication

### SUMMARY OF INVENTION

### Technical Problem

In the foregoing techniques, the system is monitored by a communication device connected to the dedicated communication line. In addition, only a person who operates the communication device connected to the dedicated communication line can know the management state and operation state of the system. Moreover, since a person who monitors the system needs to have expertise both in commands that are used to monitor the system and in the monitored result, unless he or she specializes in this area, he or she will not easily understand the monitored result that is obtained from the communication device. In the technique described in Patent Literature 1, a supervisor who monitors the system cannot know the status of the servers which provide services.

Thus, it is difficult to take prompt countermeasures that correspond to the states of the system.

An object of the present invention is to provide monitoring devices, monitoring systems, monitoring methods, and programs that can solve the foregoing problem.

### Solution to Problem

A monitoring device according to the present invention includes:

a monitoring section that monitors operation states of a plurality of servers that provide services;

a display information generation section that generates display information that allows a radio communication terminal to graphically display the operation states and process commands for the servers if information that indicates the operation states is requested from the radio communication terminal connectable to a communication network through the communication network;

a transmission section that transmits the display information generated by the display information generation section to the radio communication terminal that has requested the information that indicates the operation states; and

an instruction section that causes the servers to execute processes corresponding to the process commands if they are transmitted from the radio communication terminal.

A monitor system according to the present invention is a monitoring system having a radio communication terminal connectable to a communication network; a plurality of servers that provide services; and a monitoring device,

wherein the monitoring device includes:

a monitoring section that monitors operation states of the plurality of servers;

a display information generation section that generates display information that allows the radio communication terminal to graphically display the operation states and process commands for the servers if information that indicates the operation states is requested from the radio communication terminal through the communication network;

a transmission section that transmits the display information generated by the display information generation section to the radio communication terminal that has requested the information that indicates the operation states; and

an instruction section that causes the servers to execute processes corresponding to the process commands if they are transmitted from the radio communication terminal,

wherein the radio communication terminal includes:

a display request section that requests the monitoring device to transmit the information that indicates the operation states;

a display section that graphically displays information based on the display information transmitted from the monitoring device; and

a process request section that transmits the process command to the monitoring device based on an operation performed for the information that the display section graphically displays.

A monitoring method according to the present invention is a monitoring method that performs processes including:

monitoring operation states of a plurality of servers that provide services;

generating display information that allows a radio communication terminal connectable to a communication network to graphically display the operation states and process commands for the servers if information that indicates the operation states is requested from the radio communication terminal through the communication network;

transmitting the generated display information to the radio communication terminal that has requested the information that indicates the operation states; and

causing the servers to execute processes based on the process commands if the process commands are transmitted from the radio communication terminal.

A program according to the present invention is a program that causes a computer to execute procedures including:

monitoring operation states of a plurality of servers that provide services;

generating display information that allows a radio communication terminal connectable to a communication network to graphically display the operation states and process commands for the servers if information that indicates the operation states is requested from the radio communication terminal through the communication network;

transmitting the generated display information to the radio communication terminal that has requested the information that indicates the operation states; and

causing the servers to execute processes based on the process commands if the process commands are transmitted from the radio communication terminal.

### Advantageous Effects of Invention

As described above, according to the present invention, countermeasures can be promptly taken that correspond to the situations of the system.

The above and other objects, features, and advantages of the present invention will become apparent from the following description with reference to the accompanying drawings which illustrate an example of the present invention.

### BRIEF DESCRIPTION OF DRAWINGS

FIG. 1 is a schematic diagram showing a monitoring system according to an embodiment of the present invention;

FIG. 2 is a schematic diagram exemplifying the internal structure of a monitoring device shown in FIG. 1;

FIG. 3 is a schematic diagram exemplifying thresholds stored in a storage section shown in FIG. 2;

FIG. 4 is a schematic diagram exemplifying categorized results stored in the storage section shown in FIG. 2;

FIG. 5 is a schematic diagram exemplifying a log stored in the storage section shown in FIG. 2;

FIG. 6 is a schematic diagram exemplifying group information stored in the storage section shown in FIG. 2;

FIG. 7 is a schematic diagram exemplifying subscriber user information stored in the storage section shown in FIG. 2;

FIG. 8 is a schematic diagram exemplifying the internal structure of a supervisor terminal shown in FIG. 1;

FIG. 9 is a sequence diagram describing a monitoring method for the monitoring system shown in FIG. 1;

FIG. 10 is a schematic diagram exemplifying a display screen of a display section, shown in FIG. 8, that graphically displays data;

FIG. 11 is a schematic diagram exemplifying an operation state of a server displayed on the display section shown in FIG. 8; and

FIG. 12 is a schematic diagram exemplifying a detected result graphically displayed on the display section shown in FIG. 8.

### EXEMPLARY EMBODIMENTS

Next, with reference to the accompanying drawings, embodiments of the present invention will be described.

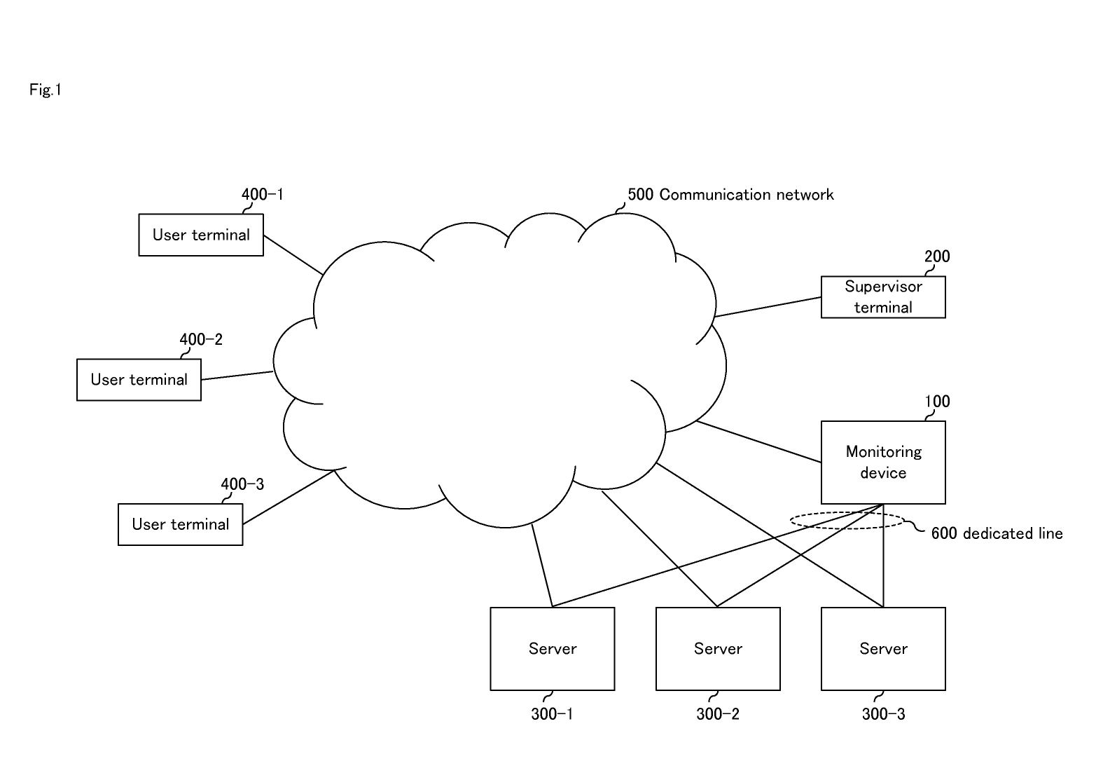

FIG. 1 shows a monitoring system according to an embodiment of the present invention.

The monitoring system according to this embodiment has monitoring device 100, supervisor terminal 200, servers 300-1 to 300-3, and user terminals 400-1 to 400-3. Monitoring device 100 is connected to servers 300-1 to 300-3 through dedicated line 600 that is a dedicated communication line. Monitoring device 100 is connected to supervisor terminal 200 through communication network 500. Servers 300-1 to 300-3 are connected to user terminals 400-1 to 400-3 through communication network 500. The communication network that connects monitoring device 100 and supervisor terminal 200 may be the same as or different from the communication network that connects servers 300-1 to 300-3 and user terminals 400-1 to 400-3. In the embodiment shown in FIG. 1, it is assumed that the number of servers is three and the number of user terminals are three. However, it should be noted that the numbers of servers and the number of user terminals are not limited to three. Likewise, in the embodiment shown in FIG. 1, it is assumed that the number of supervisor terminals 200 is one. However, it should be noted that the number of supervisor terminals 200 may depend on the number of supervisors.

User terminals 400-1 to 400-3 are communication devices that users who subscribe to services operate.

Servers 300-1 to 300-3 provide predetermined services to user terminals 400-1 to 400-3. The predetermined services are those provided over communication networks such as electronic mails that are transmitted and received, SNS (Social Networking Service), blogs, and home pages. Servers 300-1 to 300-3 may be three physical servers that are physically separated or three virtual servers that are virtually structured by one physical server or three or more physical servers. Servers 300-1 to 300-3 may have a function that controls communication network 500 and other servers. Servers 300-1 to 300-3 have been assigned services that they provide to users. Servers 300-1 to 300-3 has stored data that was generated when they provided services to user terminals 400-1 to 400-3. If the services that servers 300-1 to 300-3 provide to user terminals 400-1 to 400-3 are electronic mail services, the data are, for example, electronic mail received at the electronic mail addresses of user terminals 400-1 to 400-3 and mail boxes that store electronic mails transmitted from user terminals 400-1 to 400-3. If two servers provide services to 20 users, the first server may provide services to the first to tenth users and store data that was generated when the server provided the services to them. Likewise, the second server may provide services to the eleventh to twentieth users and store data that was generated when the server provided the services to them.

Monitoring device 100 monitors the operation states of servers 300-1 to 300-3.

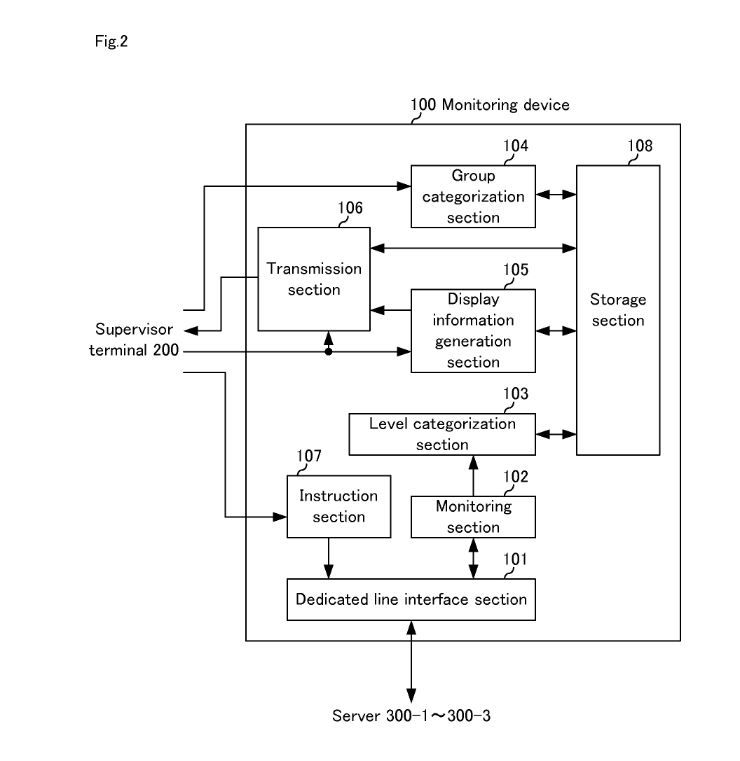

As shown in FIG. 2, monitoring device 100 shown in FIG. 1 includes dedicated line interface section 101, monitoring section 102, level categorization section 103, group categorization section 104, display information generation section 105, transmission section 106, instruction section 107, and storage section 108.

Dedicated line interface section 101 has an interface function that connects monitoring device 100 and dedicated line 600 so as to transmit and receive information among servers 300-1 to 300-3.

Monitoring section 102 monitors the operation states of servers 300-1 to 300-3 through dedicated line interface section 101. The operation state is, for example, CPU usage ratio, memory usage ratio, response time, error occurrence ratio, and the number of retries of each of servers 300-1 to 300-3.

For example, monitoring section 102 requests servers 300-1 to 300-3 to report their CPU usage ratio and memory usage ratio, receives them therefrom, and stores them so as to monitor the operation states of servers 300-1 to 300-3. In addition, monitoring section 102 transmits a predetermined signal to servers 300-1 to 300-3 and measures response times after it is transmitted until it is received so as to monitor the operation states of servers 300-1 to 300-3. Moreover, monitoring section 102 detects predetermined error patterns about data received from servers 300-1 to 300-3 and detects errors about data received from servers 300-1 to 300-3 based on CRC (Cyclic Redundancy Check) and parity check techniques so as to measure their error occurrence ratio and thereby monitor the operation states of servers 300-1 to 300-3. In addition, monitoring section 102 counts the number of retries for a retry process such as a data retransmission process for servers 300-1 to 300-3 so as to monitor the operation states of servers 300-1 to 300-3.

Monitoring section 102 outputs the monitored results to level categorization section 103.

Level categorization section 103 compares the monitored results (operation states) that are output from monitoring section 102 with thresholds prestored in storage section 108. In addition, level categorization section 103 categorizes the operation states as a plurality of levels based on the compared results. A specific categorization technique will be described later. Moreover, level categorization section 103 causes storage section 108 to store the categorized results. Alternatively, level categorization section 103 may cause storage section 108 to directly store the monitored results (numeric values) that are output from monitoring section 102.

Group categorization section 104 categorizes servers 300-1 to 300-3 as groups based on predetermined rules. In addition, group categorization section 104 causes storage section 108 to store the categorized groups. The predetermined rules include the number of users to which a server provides services, kinds of services that a server provides, a system structure, a server setup date, shared facilities (storage device, network device, etc), and a supervisor. Information, which is used for categorization as groups based on the predetermined rules, about servers 300-1 to 300-3 includes a monitored result that is output from monitoring section 102, information obtained from servers 300-1 to 300-3, and information about servers 300-1 to 300-3 that has been stored in storage section 108. When groups are categorized in a plurality of hierarchical levels, each of hierarchical levels is assigned predetermined rule which is used for categorization. Group categorization section 104 may categorize servers 300-1 to 300-3 as groups when monitoring section 102 outputs the monitored results or when supervisor terminal 200 requests group categorization section 104 to do so. Rules based on which group categorization section 104 categorizes servers 300-1 to 300-3 as groups may be selected on supervisor terminal 200 side (for example, categorized groups in a low hierarchical level of servers 300-1 to 300-3 may be changed from setup dates to supervisors).

If supervisor terminal 200 requests display information generation section 105 to transmit information that indicates the operation states of servers 300-1 to 300-3 through communication network 500, display information generation section 105 will generate display information that allows supervisor terminal 200 to graphically display the operation states and process commands for servers 300-1 to 300-3. At this point, display information generation section 105 generates display information that allows supervisor terminal 200 to graphically indicate the operation states using colors or images that correspond to levels categorized by level categorization section 103. The process commands may be commands that cause servers 300-1 to 300-3 to be remotely operated such as a restart command for servers 300-1 to 300-3, a temporarily stop command for servers 300-1 to 300-3, a restart command for servers 300-1 to 300-3 that have stopped, a program execution/change command for servers 300-1 to 300-3, a command that causes thresholds compared with monitored results to be changed, and a command that causes users who belong to servers 300-1 to 300-3 to be moved.

Display information generation section 105 generates information that allows supervisor terminal 200 to graphically display the operation states of individual groups stored in storage section 108 such that the information is included in the display information.

Transmission section 106 transmits the display information generated by display information generation section 105 to supervisor terminal 200 that has requested transmission section 106 to transmit information that indicates the operation states through communication network 500. In addition, if supervisor terminal 200 requests transmission section 106 to send a log, transmission section 106 reads it from storage section 108 and transmits it to supervisor terminal 200. The log will be described later.

When instruction section 107 receives a process command from supervisor terminal 200, instruction section 107 causes servers 300-1 to 300-3 to execute a process that corresponds to the received process command through dedicated line interface section 101.

Storage section 108 stores thresholds that level categorization section 103 uses to categorize monitored results, that are output from monitoring section 102, as a plurality of levels.

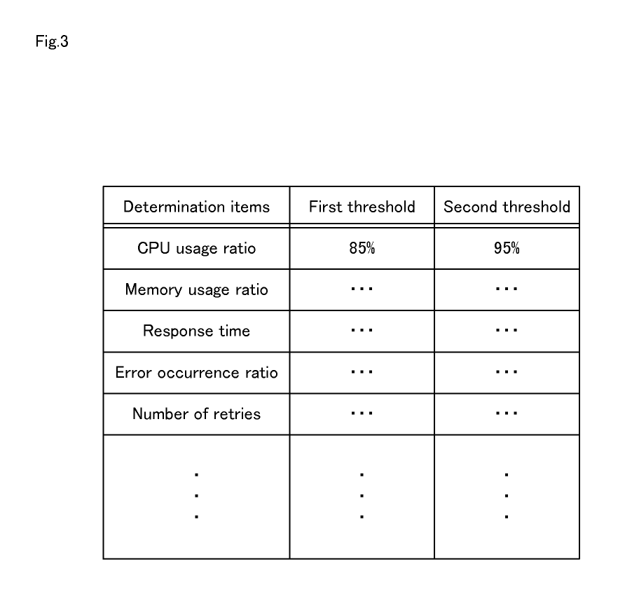

As shown in FIG. 3, storage section 108 shown in FIG. 2 has stored two thresholds for each of a plurality of determination items. For example, as shown in FIG. 3, storage section 108 has stored as the determination items “CPU usage ratio,” “memory usage ratio,” “ response time,” “error occurrence ratio,” and “number of retries.” In addition, storage section 108 has stored a first threshold and a second threshold for each of the determination items. Level categorization section 103 categorizes the monitored results as three levels based on these two thresholds. Specifically, if a monitored result is less than the first threshold, level categorization section 103 categorizes the monitored result as level A. If the monitored result is equal to or greater than the first threshold and less than the second threshold, level categorization section 103 categorizes the monitored result as level B. If the monitored result is equal to or greater than the second threshold, level categorization section 103 categorizes the monitored result as level C. In this case, level A may be referred to as “normal state,” level B as “alert state,” and level C as “dangerous state.” Alternatively, a plurality of sets of thresholds may be assigned and they may be selected depending on periods for which level categorization section 103 categorizes monitored results as levels.

In addition, storage section 108 stores the results concerning which level categorization section 103 categorizes the monitored results as levels.

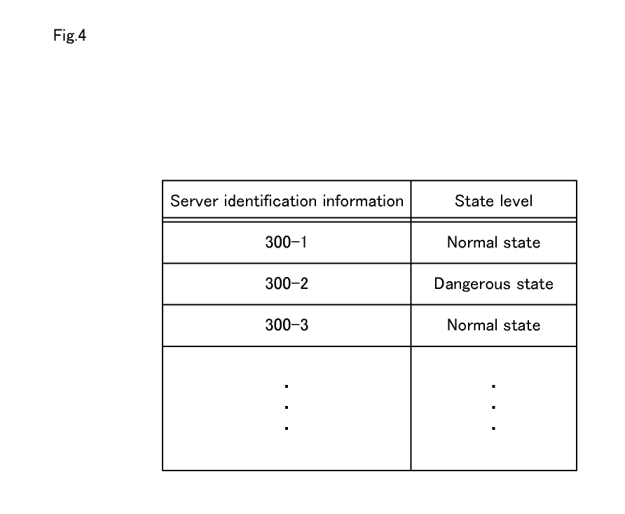

As shown in FIG. 4, storage section 108 shown in FIG. 2 has correlatively stored server identification information assigned to servers 300-1 to 300-3 and the results categorized by level categorization section 103. For example, as shown in FIG. 4, storage section 108 has correlatively stored server identification information “300-1” and state level “normal state,” which denotes that the level of the operation state of the server identified with server identification information “300-1” is a “normal state” (above described “level A”). Storage section 108 has correlatively stored server identification information “300-2” and state level “dangerous state,” which denotes that the level of the operation state of the server identified with server identification information “300-2” is a “dangerous state” (above described “level C”). Storage section 108 has correlatively stored server identification information “300-3” and state level “normal state,” which denotes that the level of the operation state of the server identified with server identification information “300-3” is a “normal state” (above described “level A”).

FIG. 4 shows an example in which storage section 108 has stored the state level of each server. Level categorization section 103 categorizes the monitored results of monitoring section 102 as a plurality of levels for each of determination items shown in FIG. 3. Thus, storage section 108 stores state levels of individual determination items. If storage section 108 stores the state levels of each server as shown in FIG. 4, level categorization section 103 may cause storage section 108 to store the average of state levels of the determination items of one server as the state level of the server. Alternatively, level categorization section 103 may cause storage section 108 to store the worst state level (for example, above described “level C”) of state levels of the determination items of one server as the state level of the server. Alternatively, level categorization section 103 may score the difference between the numeric value of each of the monitored results that are output from monitoring section 102 and the threshold of each of the determination items and categorize the total or average of the obtained points as the state level of each server.

In addition, storage section 108 stores a log of instructions that instruction section 107 has performed.

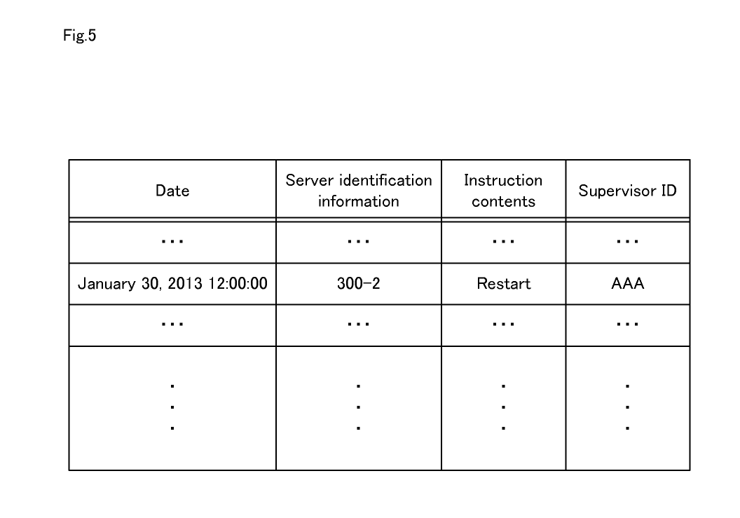

As shown in FIG. 5, storage section 108 shown in FIG. 2 has stored a log that correlates server identification information, instruction contents, supervisor ID (and/or supervisor name correlatively stored with supervisor ID), and date. If a process command is transmitted from supervisor terminal 200, the instruction contents are contents of an instruction that instruction section 107 performs to servers 300-1 to 300-3 through dedicated line interface section 101. The supervisor ID may be identification information that identifies a supervisor who operated supervisor terminal 200 or identification information assigned to supervisor terminal 200. For example, as shown in FIG. 5, storage section 108 has correlatively stored date and time “Jan. 30, 2013 12:00:00,” server identification information “300-2,” instruction contents “restart,” and supervisor ID “AAA,” which indicates a log that denotes that instruction section 107 restarted server 300-2 based on process command “restart” transmitted from a supervisor terminal that a supervisor identified with supervisor ID “AAA” operated.

In addition, storage section 108 stores the results concerning which group categorization section 104 has categorized servers 300-1 to 300-3 as groups.

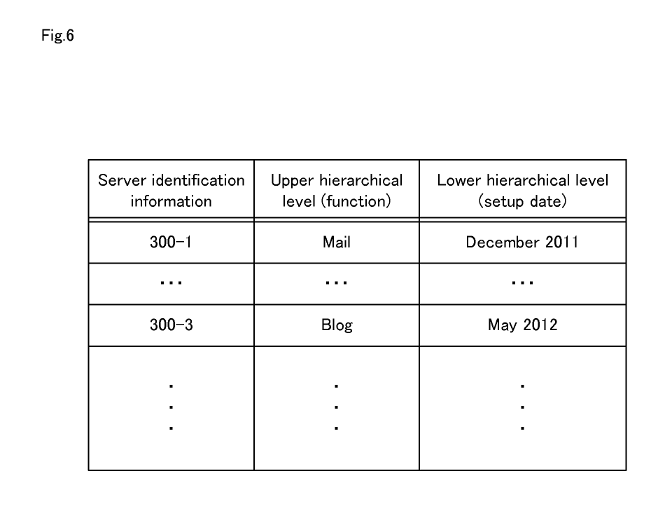

As shown in FIG. 6, storage section 108 shown in FIG. 2 has stored group categorized information that indicates hierarchical levels and groups to which servers 300-1 to 300-3 belong. Group categorization section 104 presets the group categorized information based on predetermined rules. For example, as shown in FIG. 6, storage section 108 has correlatively stored server identification information “300-1,” upper hierarchical level (function) “mail,” and lower hierarchical level (setup date) “December 2011,” which denotes that server 300-1 belongs to a function group in the upper hierarchical level and to a setup date group in the lower hierarchical level. In other words, server 300-1 belongs to a mail group (group of servers that work as mail servers) in the upper hierarchical level and to a group that was set up in December 2012 in the lower hierarchical level. In addition, storage section 108 has correlatively stored server identification information “300-3,” upper hierarchical level (function) “blog,” and lower hierarchical level (setup date) “May 2012,” which denotes that server 300-3 belongs to a blog group (group of servers that provide blog service) in the upper hierarchical level and to a group that was set up in May 2012 in the lower hierarchical level.

The number of hierarchical levels categorized by group categorization section 104 is not limited to two hierarchical levels: upper hierarchical level and lower hierarchical level. In addition, groups assigned to individual hierarchical levels may be groups of server types such as a process server and a storage server. Alternatively, groups assigned to individual hierarchical levels may be groups of supervisors. Alternatively, groups assigned to individual hierarchical levels may be the number of users who subscribe to services, the types of services, system structures, and shared facilities (storage device, network device, etc).

In addition, storage section 108 stores subscriber user information that denotes to what servers 300-1 to 300-3 user terminals 400-1 to 400-3 belong, namely user terminals 400-1 to 400-3 receive what services from what servers 300-1 to 300-3.

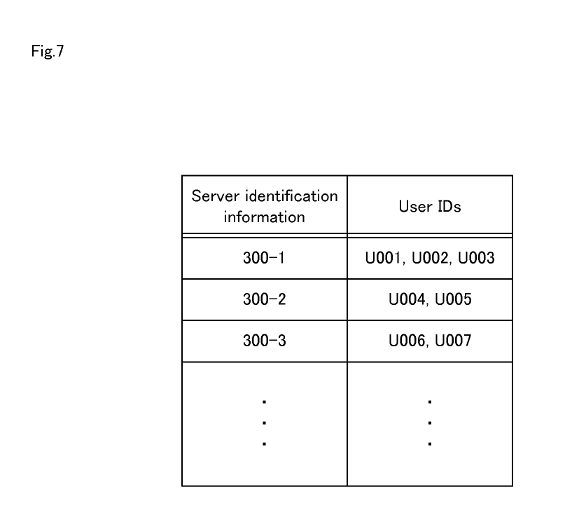

As shown in FIG. 7, storage section 108 shown in FIG. 2 has correlatively stored server identification information and user IDs. In other words, as described above, storage section 108 has stored information that denotes what servers provide what services to what users. As the information, storage section 108 has stored user IDs assigned to users to which servers 300-1 to 300-3 provide services. The user IDs of the users who use servers 300-1 to 300-3 can be identified based on the subscriber user information.

Supervisor terminal 200 is a mobile radio communication terminal connectable to communication network 500. For example, like a smartphone, supervisor terminal 200 can always be connected to communication network 500 any time and any place as long as supervisor terminal 200 is present in a radio communication zone. In addition, like a smartphone, supervisor terminal 200 is not provided with operation keys for inputting characters. The user inputs information to supervisor terminal 200 using a touch panel function. Since supervisor terminal 200 performs processes any time and any place, as will be described later, it is preferred that supervisor terminal 200 be a mobile communication terminal that the user always carries.

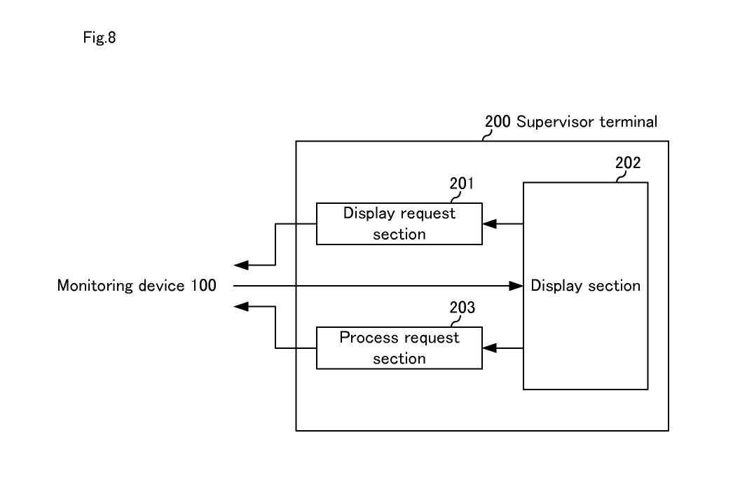

As shown in FIG. 8, supervisor terminal 200 shown in FIG. 1 has display request section 201, display section 202, and process request section 203. FIG. 8 shows only principal constituent elements of supervisor terminal 200 according to this embodiment.

When the supervisor inputs a predetermined command to supervisor terminal 200, display request section 201 requests monitoring device 100 to transmit information that indicates the operation states of servers 300-1 to 300-3.

Display section 202 graphically displays information based on the display information transmitted from monitoring device 100. The display information includes information that indicates the operation states of servers 300-1 to 300-3 and process commands issued to servers 300-1 to 300-3. Display section 202 has a touch panel function that detects that an object is touching or approaching itself.

Process request section 203 transmits a process command to monitoring device 100 based on an operation performed on information that display section 202 has graphically displayed. This operation is a touching or approaching operation detected by display section 202.

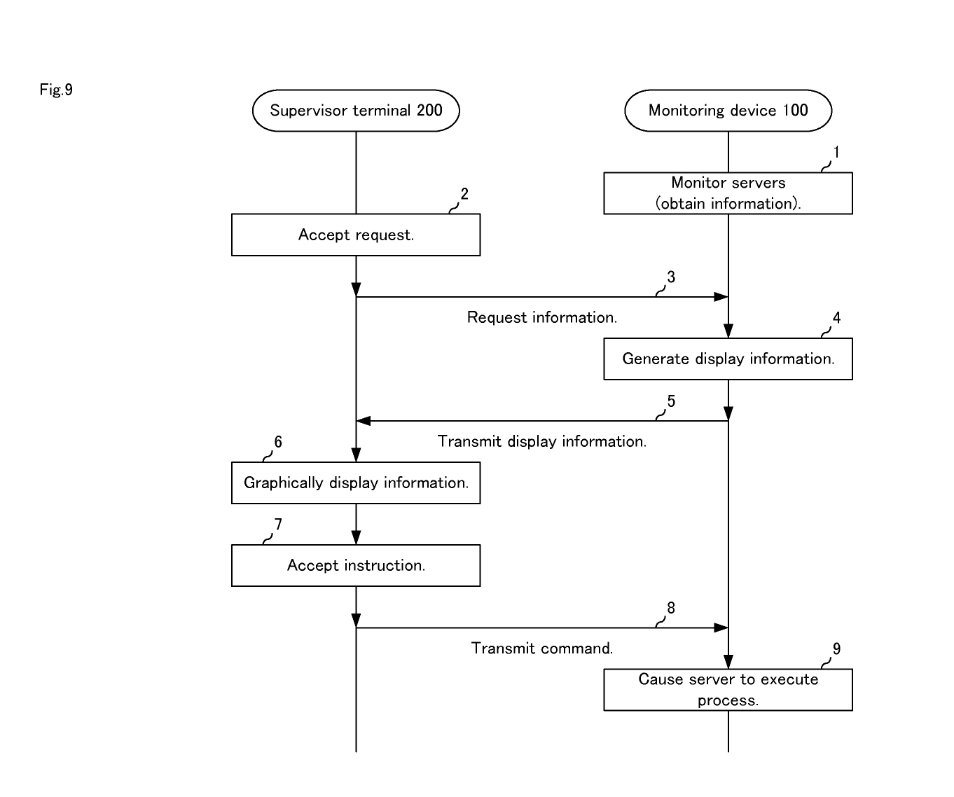

Next, with reference to FIG. 9, a monitoring method for the monitoring system according to the embodiment shown in FIG. 1 will be described.

Monitoring section 102 of monitoring device 100 monitors servers 300-1 to 300-3 through dedicated line interface section 101 at step 1. As described above, in the monitoring method, monitoring section 102 requests servers 300-1 to 300-3 to transmit the states of individual determination items (for example, monitoring section 102 monitors and controls them using SNMP (Simple Network Management Protocol)) and measures their response times. Servers 300-1 to 300-3 read their operation states (CPU usage ratio, memory usage ratio, etc) from their storage section called MIB (Management Information Base) in reply to state requests from monitoring device 100 and transmit the obtained information as state information to monitoring device 100. As the monitor timings, that monitoring section 102 performs the foregoing operation at predetermined intervals, at a predetermined time, or in reply to any request issued from supervisor terminal 200.

Thereafter, level categorization section 103 categorizes the monitored results of monitoring section 102 as a plurality of levels based on thresholds stored in storage section 108. Thereafter, level categorization section 103 causes storage section 108 to store the categorized results.

At this point, if there is a server whose state level has been categorized as “dangerous state,” monitoring device 100 generates a message that indicates such a state level and transmits it using electronic mail or SMS (Short Message Service) to the mail address, telephone number, or IP address of supervisor terminal 200 (a plurality of supervisor terminals 200).

When the supervisor performs a predetermined operation on supervisor terminal 200, it accepts a request for information that indicates the operation states of servers 300-1 to 300-3 at step 2. Thereafter, display request section 201 requests monitoring device 100 to transmit information that indicates the operation states of servers 300-1 to 300-3 at step 3. The operation that the supervisor performs on supervisor terminal 200 may be an operation that he or she touches or approaches display section 202 with his or her finger in a predetermined pattern or selects an item corresponding to the information that the supervisor requires from the menu displayed on display section 202.

When supervisor terminal 200 requests monitoring device 100 to transmit information that indicates the operation states of servers 300-1 to 300-3, display information generation section 105 reads the operation states of servers 300-1 to 300-3 from storage section 108. Thereafter, display information generation section 105 generates display information that allows supervisor terminal 200 to graphically display the operation states and to process commands at step 4. Storage section 108 has stored the operation states categorized as the foregoing levels. Thus, display information generation section 105 generates display information that allows supervisor terminal 200 to graphically display the operation states using colors and images that correspond to the levels. Alternatively, when level categorization section 103 causes storage section 108 to store the categorized result, display information generation section 105 may generate display information and cause storage section 108 to store the generated display information.

For example, if the state level of server 300-1 is the foregoing “normal state,” display information generation section 105 generates display information that allows supervisor terminal 200 to graphically display an image such as an icon of server 300-1 in blue. If the state level of server 300-1 is the foregoing “alert state,” supervisor terminal 200 generates display information that allows supervisor terminal 200 to graphically display an image such as an icon of server 300-1 in yellow. If the state level of server 300-1 is the foregoing “dangerous state,” supervisor terminal 200 generates display information that allows supervisor terminal 200 to graphically display an image such as an icon of server 300-1 in red. Alternatively, if the state level of server 300-1 is the foregoing “normal state,” display information generation section 105 may generate display information that allows supervisor terminal 200 to graphically display an image such as an icon of server 300-1 that indicates that the state of server 300-1 is normal such as a smiley face or “◯”. If the state level of server 300-1 is the foregoing “alert state,” display information generation section 105 may generate display information that allows supervisor terminal 200 to graphically display an image such as an icon of server 300-1 that attracts an attention (for example, “Δ”). If the state level of server 300-1 is the foregoing “dangerous state,” display information generation section 105 may generate display information that allows supervisor terminal 200 to graphically display an image such as an icon of server 300-1 that denotes that a dangerous situation will occur unless appropriate countermeasures are taken (for example “x”).

The display information includes not only the operation states of servers 300-1 to 300-3, but also the states of groups in each hierarchical level to which servers 300-1 to 300-3 belong. Display information generation section 105 may generate display information that allows supervisor terminal 200 to display an image corresponding to the worst level of servers that belong to one group as an image that indicates the group. If groups are categorized as a plurality of hierarchical levels, display information generation section 105 performs the same display information generation process for groups categorized as upper hierarchical levels.

The process commands for servers that supervisor terminal 200 graphically displays include, for example, selection buttons that indicate process commands and a menu of process commands.

When display information generation section 105 generates display information, transmission section 106 transmits it to supervisor terminal 200 at step 5.

When supervisor terminal 200 receives display information, display section 202 graphically displays the operation states and process commands of servers 300-1 to 300-3 based on the display information at step 6. As a result, the supervisor can intuitively perceive the operation states of servers 300-1 to 300-3 using colors and shapes of icons thereof.

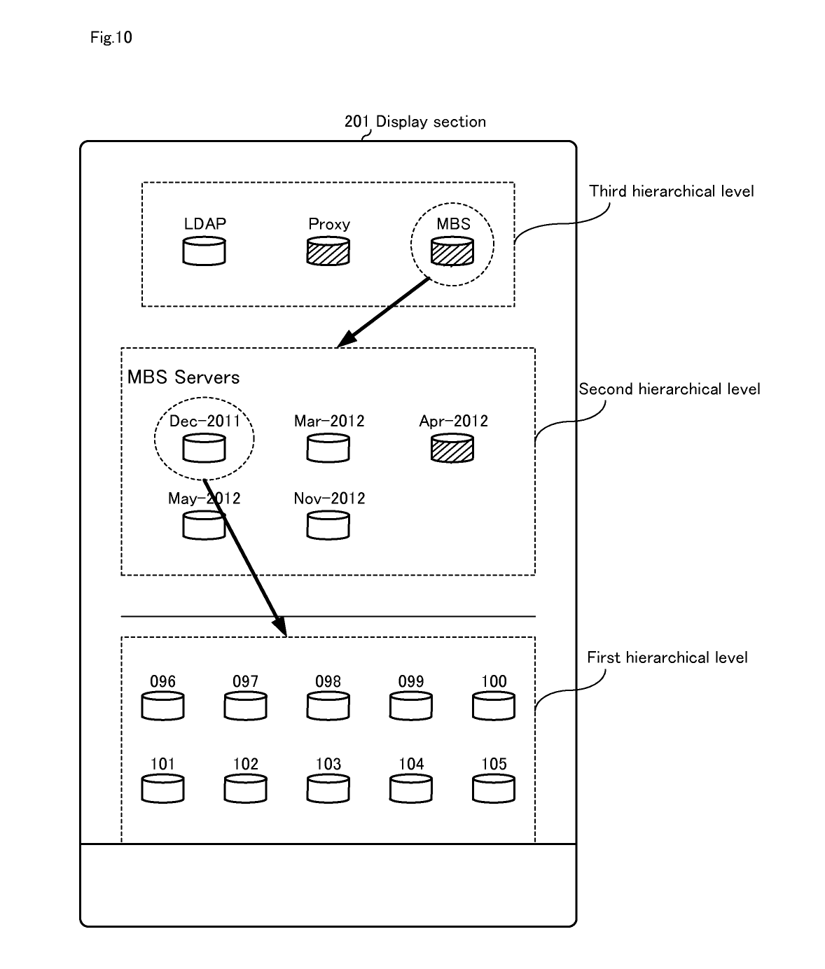

FIG. 10 shows an example of a display screen on which display section 202 shown in FIG. 8 graphically displays information. In this example, it is assumed that there are three hierarchical levels.

As shown in FIG. 10, when the supervisor selects one of the images that corresponds to a group from among a plurality of groups (LDAP, Proxy, MBS) in an upper hierarchical level (categorized as function groups) as a third hierarchical level display region on display section 202, servers that belong to the group are categorized as groups in a lower hierarchical level and images corresponding to the groups are displayed in a second hierarchical level display region. When the supervisor selects one of the images that corresponds to a group from among a plurality of groups (categorized as groups corresponding to setup dates) which are displayed in the second hierarchical level display region, servers that belong to the group are displayed in a first hierarchical level display region. These images are displayed in colors and shapes corresponding to the state levels of the operation states (in the example shown in FIG. 10, groups whose state levels are bad are hatched). When the supervisor requests information that indicates the operation state of the overall system, display section 202 may display a log-in screen that prompts him or her to input a set of the supervisor ID and password along with the image that indicates the operation state of the overall system as a fourth hierarchical level. When the supervisor selects an image corresponding to one server of those displayed in the first hierarchical level display region, display section 202 displays the operation state of the server.

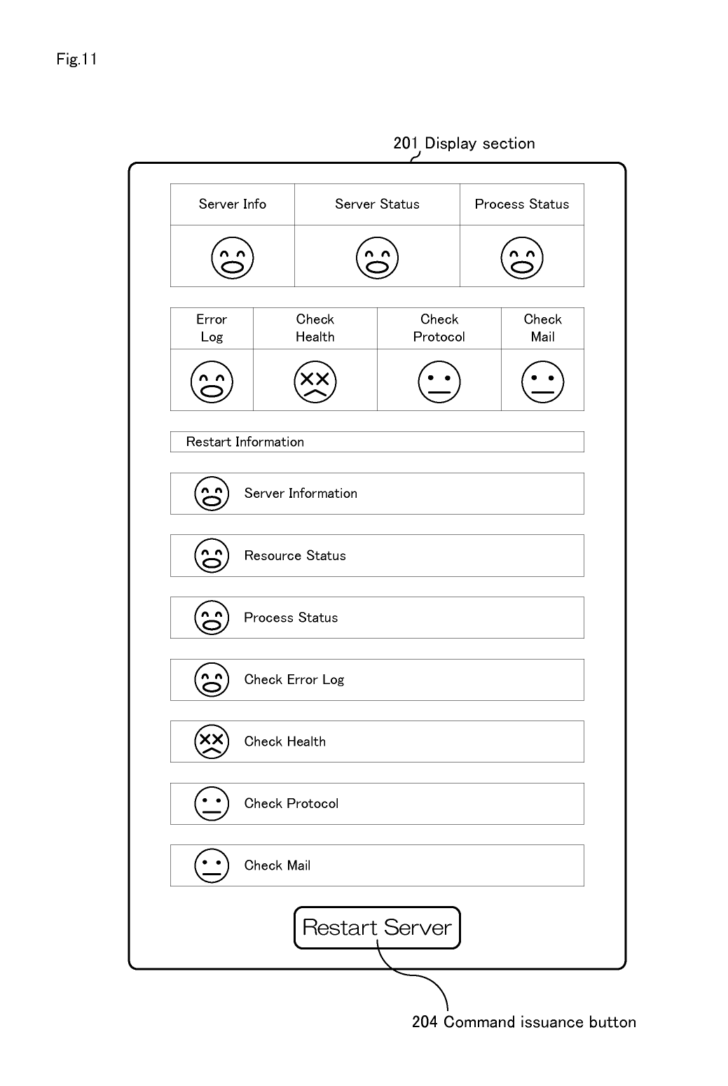

If one of the servers that belong to the first hierarchical level shown in FIG. 10 is selected, display section 202 graphically displays states (levels) of individual determination items of the server as images that differ in colors and shapes such that the supervisor can intuitively perceive the states that correspond to the levels categorized by level categorization section 103 as shown in FIG. 11. In addition, display section 202 displays command issuance button 204 that remotely issues a process command as shown in FIG. 11. Command issuance button 204 may be displayed on a screen different from the display screen for the states (levels) of individual determination items of the server.

After display section 202 displays the foregoing display information, when the supervisor performs a predetermined operation on supervisor terminal 200, it accepts a process command at step 7. Thereafter, process request section 203 transmits the process command to monitoring device 100 at step 8. If display section 202 displays command issuance button 204 shown in FIG. 11, the supervisor may select it on display section 202. If display section 202 displays a menu of process commands, the supervisor may select his or her desired process command from the menu. The process command is transmitted as operation identification information that can identify the command. Process request section 203 also transmits server identification information that identifies the server that the supervisor has selected on display section 202 along with the process command. A server may be selected from images of groups displayed in a display region other than the first hierarchical level display region. In this case, process request section 203 may transmit the process command and server identification information to monitoring device 100 such that supervisor terminal 200 extracts servers whose state levels are “dangerous state” and “alert state” from among those that belong to the group and executes the process command for the extracted servers.

When supervisor terminal 200 transmits the process command to instruction section 107, instruction section 107 causes servers 300-1 to 300-3 identified with the server identification information transmitted along with the process command to execute the process corresponding to the process command through dedicated line interface section 101 at step 9. Thereafter, servers 300-1 to 300-3 perform the process corresponding to the command. When supervisor terminal 200 transmits the process command to instruction section 107, instruction section 107 may authenticate the supervisor using the supervisor ID, password, and so forth and then cause servers 300-1 to 300-3 to execute the process corresponding to the process command.

Instructions performed by instruction section 107 are stored as a log shown in FIG. 5 in storage section 108. If supervisor terminal 200 requests a log, transmission section 106 reads the log from storage section 108 and transmits it to supervisor terminal 200. Since display section 202 of supervisor terminal 200 displays the log, the supervisor can recognize remote operations that he, she, or other supervisors have performed for servers 300-1 to 300-3. Alternatively, transmission section 106 may transmit the log to supervisor terminal 200 along with display information.

Alternatively, transmission section 106 may transmit the result that indicates the instructions that instruction section 107 has performed to the mail address, telephone number, IP address, or the like of supervisor terminal 200 (or supervisor terminals 200).

If the process command is a restart command for the server, instruction section 107 reads the log of the server identified with the server identification information transmitted along with the process command from storage section 108. If the log indicates a restart operation of the server in a predetermined time, transmission section 106 may notify supervisor terminal 200 of this state along with the past restart operation and confirmation for the restart operation. If a process command that causes the server to restart is transmitted to instruction section 107 again, instruction section 107 may cause the server to restart.

If the state level of a server remains in “dangerous state” after it has been restarted a predetermined number of times in a predetermined time, display information generation section 105 may generate display information that allows a process command that moves all or part of users that belong to the server to be graphically displayed. When the supervisor selects a selection button that causes the users to be moved on display section 202, process request section 203 transmits the process command to monitoring device 100. When monitoring device 100 receives the process command, instruction section 107 causes the users that belong to the server to be moved. At this point, the supervisor may select users to be moved (on display section 202). Alternatively, a predetermined number of users, a predetermined ratio of users, or users who satisfy a predetermined condition of those who subscribe to the service of the server may be automatically selected. Specifically, instruction section 107 causes a physical server to generate a new virtual server having the same specifications as the server identified with the server identification information transmitted along with the process command. After the new server is created corresponding to the instruction, the setting and data for users to be moved are changed from the server identified with the server identification information transmitted together with the process command to the newly created server. Instruction section 107 transmits the move instruction to these servers. After monitoring device 100 receives the execution result of the move instruction for the relevant users from these servers, transmission section 106 notifies supervisor terminal 200 of the result. At this point, transmission section 106 may create a message that describes the state and transmit the message using electronic mail or SMS to the mail address, telephone number, IP address, or the like of supervisor terminal 200 (or plurality of terminals). Alternatively, all or some of the users may be moved to a low load server instead of a newly created virtual server.

Supervisor terminal 200 may set up monitoring periods of servers 300-1 to 300-3. For example, the supervisor may select a monitoring (categorizing) period from “one day,” “latest one week,” “latest one month,” “latest three months,” “latest six months,” “all period” on supervisor terminal 200. Display information generation section 105 may generate display information based on the monitored (categorized) result for the period selected by the supervisor. Transmission section 106 may transmit the generated display information to supervisor terminal 200. In this case, it is more preferred that storage section 108 have stored thresholds corresponding to individual periods and that display information generation section 105 generate display information based on the monitored (categorized) results in the period selected by the supervisor and the thresholds corresponding to the selected period. Since the operation states of servers 300-1 to 300-3 in intermediate and long periods are visually and perceivably displayed, servers that have problems can be easily detected and thereby appropriate countermeasures can be taken in advance.

Alternatively, group categorization section 104 may categorize servers as groups depending on the characteristics of servers' structures (for example, depending on whether same devices such as a network device and a storage device are used). Storage section 108 calculates the average of values of monitored results in each group and obtains the deviations between the average and the values of the monitored results of individual servers as indexes. Servers that deviate from the normal operation state may be detected based on the deviations. Display information generation section 105 may add the results to display information that allows supervisor terminal 200 to graphically display information.

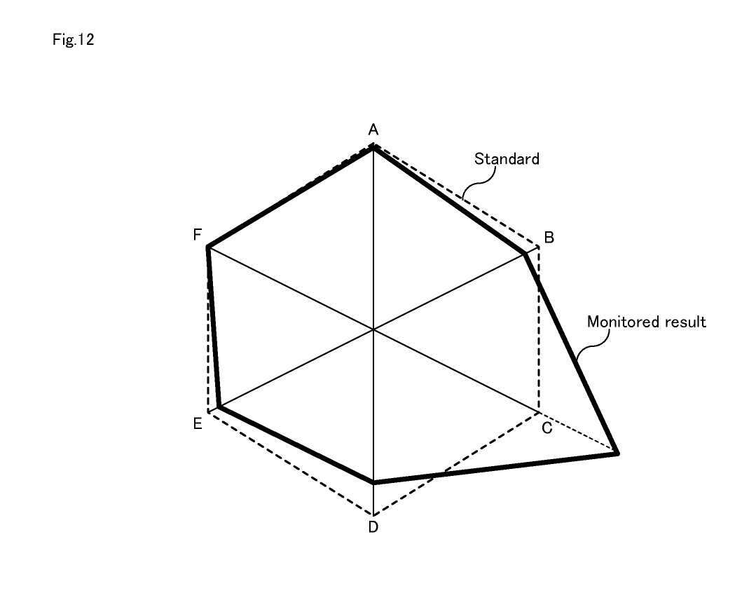

Display section 202 shown in FIG. 8 can graphically display information that denotes which monitored results of servers largely deviate from the standard as shown in FIG. 12. The supervisor can take appropriate countermeasures that minimize the deviations such that the states of the servers become the standard state and the likelihood of server failures decreases in the overall system. When the supervisor selects an image corresponding to a group in the second hierarchical level or third hierarchical level shown in FIG. 10, display section 202 may display servers that belong to the group in the order of higher deviations.

Display section 202 may graphically display process commands after the supervisor who operates supervisor terminal 200 has been authenticated as a high level supervisor.

Thus, the supervisor can visually perceive the current operation states of servers any time and any place. The supervisor can remotely control the servers based on the monitored results. In addition, since a log is transmitted to the supervisor terminal, the supervisor can perceive countermeasures that operators and other supervisors are taking on their own. Thus, a plural of supervisors can share accurate information and the operators can concentrate on recovery works.

As a result, the servers can quickly recover from their failures. Since the operators can recover the servers from failures based on information that is graphically displayed, they do not need to have expertise of command input and so forth. As a result, operational mistakes can be reduced.

Processes that individual constituent elements of monitoring device 100 perform may be executed by logic circuits that have been created for this purpose. A computer program that describes processes as a procedure (hereinafter, referred to as the program) may be recorded on a record medium from which monitoring device 100 can read the program. Monitoring device 100 may read the program from the record medium and execute the program. The record medium from which monitoring device 100 can read the program is a movable record medium such as a floppy (registered trademark) disk, a magneto-optical disc, a DVD, or a CD; a memory such as a ROM or a RAM built in monitoring device 100; or an HDD. The program recorded on the record medium is read by a CPU (not shown) of monitoring device 100. Processes similar to the foregoing are executed under the control of the CPU. The CPU operates as a computer that executes the program that is read from the record medium.

All or part of the foregoing embodiment may be described in the following supplements, but not limited thereto.

(Supplement 1) A monitoring device, including:

a monitoring section that monitors operation states of a plurality of servers that provide services;

a display information generation section that generates display information that allows a radio communication terminal to graphically display the operation states and process commands for the servers if information that indicates the operation states is requested from the radio communication terminal connectable to a communication network through the communication network;

a transmission section that transmits the display information generated by the display information generation section to the radio communication terminal that has requested the information that indicates the operation states; and an instruction section that causes the servers to execute processes corresponding to the process commands if they are transmitted from the radio communication terminal.

(Supplement 2) The monitoring device as set forth in supplement 1, further including:

a level categorization section that compares the operation states with preset thresholds and categorizes the operation states as a plurality of levels based on the compared results,

wherein the display information generation section generates the display information that allows a radio communication terminal to graphically display the operation states using colors or images corresponding to the levels categorized by the level categorization section.

(Supplement 3) The monitoring device as set forth in supplement 1 or 2, further including:

a storage section that stores a log of instructions performed by the instruction section,

wherein the transmission section reads the log from the storage section and transmits the log to the radio communication terminal if the log is requested therefrom.

(Supplement 4) The monitoring device as set forth in any one of supplements 1 to 3, further including:

a group categorizing section that categorizes the plurality of servers as groups based on a predetermined rule,

wherein the display information generation section generates information that allows the radio communication terminal to graphically display the operation states of the individual groups such that the information is included in the display information.

(Supplement 5) A monitor system having a radio communication terminal connectable to a communication network; a plurality of servers that provide services; and a monitoring device,

wherein the monitoring device includes:

a monitoring section that monitors operation states of the plurality of servers;

a display information generation section that generates display information that allows the radio communication terminal to graphically display the operation states and process commands for the servers if information that indicates the operation states is requested from the radio communication terminal through the communication network;

a transmission section that transmits the display information generated by the display information generation section to the radio communication terminal that has requested the information that indicates the operation states; and

an instruction section that causes the servers to execute processes corresponding to the process commands if they are transmitted from the radio communication terminal, and

wherein the radio communication terminal includes:

a display request section that requests the monitoring device to transmit the information that indicates the operation states;

a display section that graphically displays information based on the display information transmitted from the monitoring device; and

a process request section that transmits the process command to the monitoring device based on an operation performed for the information that the display section graphically displays.

(Supplement 6) The monitor system as set forth in supplement 5,

wherein the radio communication terminal is always connectable to the communication network and is not provided with operation keys for inputting characters.

(Supplement 7) The monitor system as set forth in supplement 5 or 6,

wherein the display section has a touch panel function that detects that an object is touching or approaching the display section, and

wherein the process request section transmits the process commands as the display section detects that the object is touching or approaching the display section.

(Supplement 8) The monitor system as set forth in any one of supplements 5 to 7,

wherein the radio communication terminal is a smartphone.

(Supplement 9) A monitoring method that performs processes including:

monitoring operation states of a plurality of servers that provide services;

generating display information that allows a radio communication terminal connectable to a communication network to graphically display the operation states and process commands for the servers if information that indicates the operation states is requested from the radio communication terminal through the communication network;

transmitting the generated display information to the radio communication terminal that has requested the information that indicates the operation states; and

causing the servers to execute processes based on the process commands if the process commands are transmitted from the radio communication terminal.

(Supplement 10) A program that causes a computer to execute procedures including:

monitoring operation states of a plurality of servers that provide services;

generating display information that allows a radio communication terminal connectable to a communication network to graphically display the operation states and process commands for the servers if information that indicates the operation states is requested from the radio communication terminal through the communication network;

transmitting the generated display information to the radio communication terminal that has requested the information that indicates the operation states; and

causing the servers to execute processes based on the process commands if the process commands are transmitted from the radio communication terminal.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. A monitoring device, comprising:
a monitoring section that monitors operation states of a plurality of servers that provide services;
a display information generation section that generates display information that allows a radio communication terminal to graphically display said operation states and process commands for said servers if information that indicates said operation states is requested from said radio communication terminal connectable to a communication network through the communication network;
a transmission section that transmits the display information generated by said display information generation section to the radio communication terminal that has requested the information that indicates said operation states; and
an instruction section that causes said servers to execute processes corresponding to said process commands if they are transmitted from said radio communication terminal.

2. The monitoring device as set forth in claim 1, further comprising:
a level categorization section that compares said operation states with preset thresholds and categorizes the operation states as a plurality of levels based on the compared results,
wherein said display information generation section generates the display information that allows a radio communication terminal to graphically display the operation states using colors or images corresponding to the levels categorized by said level categorization section.

3. The monitoring device as set forth in claim 1, further comprising:
a storage section that stores a log of instructions performed by said instruction section,
wherein said transmission section reads the log from the storage section and transmits the log to the radio communication terminal if said log is requested therefrom.

4. The monitoring device as set forth in claim 1, further comprising:
a group categorizing section that categorizes said plurality of servers as groups based on a predetermined rule,
wherein said display information generation section generates information that allows said radio communication terminal to graphically display said operation states of said individual groups such that the information is included in said display information.

5. A monitor system having a radio communication terminal connectable to a communication network; a plurality of servers that provide services; and a monitoring device,
wherein said monitoring device includes:
a monitoring section that monitors operation states of said plurality of servers;
a display information generation section that generates display information that allows said radio communication terminal to graphically display said operation states and process commands for said servers if information that indicates said operation states is requested from said radio communication terminal through the communication network;
a transmission section that transmits the display information generated by said display information generation section to the radio communication terminal that has requested the information that indicates said operation states; and
an instruction section that causes said servers to execute processes corresponding to said process commands if they are transmitted from said radio communication terminal, and
wherein said radio communication terminal includes:
a display request section that requests said monitoring device to transmit the information that indicates said operation states;
a display section that graphically displays information based on said display information transmitted from said monitoring device; and
a process request section that transmits said process command to said monitoring device based on an operation performed for the information that said display section graphically displays.

6. The monitor system as set forth in claim 5,
wherein said radio communication terminal is always connectable to said communication network and is not provided with operation keys for inputting characters.

7. The monitor system as set forth in claim 5,
wherein said display section has a touch panel function that detects that an object is touching or approaching the display section, and
wherein said process request section transmits said process commands as said display section detects that the object is touching or approaching the display section.

8. The monitor system as set forth in claim 5,
wherein said radio communication terminal is a smartphone.

9. A monitoring method that performs processes comprising:
monitoring operation states of a plurality of servers that provide services;
generating display information that allows a radio communication terminal connectable to a communication network to graphically display said operation states and process commands for said servers if information that indicates said operation states is requested from said radio communication terminal through the communication network;
transmitting said generated display information to the radio communication terminal that has requested the information that indicates said operation states; and
causing said servers to execute processes based on said process commands if said process commands are transmitted from said radio communication terminal.
